(19) United States
(12) Patent Application Publication
(10) Pub. No.: US 2003/0086483 A1
(43) Pub. Date: May 8, 2003

(54) Method and apparatus for spread spectrum signal acquisition

(75) Inventors: Saul R. Dooley, Reigate (GB); Amites Sarkar, Crawley (GB); Andrew T. Yule, East Grinstead (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/265,580

(22) Filed: Oct. 7, 2002

(30) Foreign Application Priority Data
Nov. 2, 2001 (GB) 0126325.0

(51) Int. Cl. H04B 1/69

(52) U.S. Cl. 375/147

(57) ABSTRACT

The present invention provides for a method of acquiring direct sequence spread spectrum signals and in particular, GPS signals, including the steps of obtaining an integration result by avoiding integration over bit edges, and includes the steps of splitting the received signal (A) into a plurality of signal chunks alternatively across a respective plurality of channels (B,C), each channel being arranged to carry a series of signal chunks, the division being controlled in a timed manner responsive to the signal bit period so that the signal chunks of one of the series signals do not include bit edges.

### FIELD OF INVENTION

The present invention relates to a method and apparatus for direct sequence spread spectrum signal acquisition employing integration over multiple bit periods and in a manner which avoids coherent integration, and thus correlation over bit edges.

### BACKGROUND TO INVENTION

As is commonly known, in order to accurately compute its location, a Global Positioning System (GPS) receiver determines relative times of arrival of direct sequence spread spectrum signals transmitted simultaneously from a plurality of GPS satellites and hereinafter referred to as GPS signals. This involves the computation of pseudoranges from the GPS receiver to each of the GPS satellites, which pseudoranges serve to represent the time delays measured between the signal received from each satellite and a local clock signal.

GPS receivers commonly employ correlation methods for the determination of pseudoranges. Once the RF signal has been received from the GPS satellite, it is down converted and a correlation receiver is arranged to multiply the received signal by a stored code signal and the resulting signal is then integrated in order to complete the correlation process. Acquisition of the signal then occurs once the time delay between the received signal and the local clock signal has been determined.

It is also appreciated that current GPS implementations do not allow GPS reception in areas of significant GPS signal attenuation, for example in urban canyons or indoors. GPS receivers are generally arranged to integrate for a maximum of 1 ms although it is appreciated that, the longer the integration time, the greater is the sensitivity that can be achieved in the GPS receiver. Indeed, if one were to tolerate long integration periods, it would prove possible to acquire GPS signals in harsh signal environments and, in particular, indoors.

It is appreciated that there is a combined sensitivity/acquisition time trade-off for GPS receivers. Although sensitivity can be readily improved, this has an adverse effect on acquisition time. With current implementations involving serial searches, this proves problematic because there is a non-linear relationship between sensitivity and acquisition time. For example, it has previously been noted that processing gain is achieved by reducing the noise variance of the integrated power. This can be achieved either coherently and/or non-coherently. The gain and search time as a function of non-coherent power sums N, and the coherent pre-detection interval (PDI) in milliseconds, can be represented as: Processing gain=10 log [PDI√N] dB.

Search time increase=PDI (due to increased PDI)×PDI (due to frequency step reduction)×N (number of non-coherent sums)=N×(PDI)².

Thus, it can be appreciated that, for a 100 ms search time with coherent PDI=10 ms and 10 non-coherent sums, the processing gain is 15 dB but the search time increases by a factor of 1000.

Acquisition time then becomes problematic since if 15 dB gain is required to detect the signal, the acquisition time goes up from in the region of 1 second to over half an hour.

What would therefore be advantageous is a long integration technique so as to enable high sensitivity but which would not severely impact computation, and thus acquisition, time. Also, it is valuable to have a technique that will prove effective without requiring assistance.

Long integration techniques are usually based on receiving assistance messages. WO-A-00/14560 for example discloses the transmission of a GPS time signal. Also, some known techniques are based upon coherent integration at up to 50 ms, or the non-coherent integration serving to non-coherently sum 10 ms chunks of the incoming signal.

While it is appreciated that coherent integration comprises the optimal form of integration. Such integration requires the determination of the bit polarities of the process signal by means of a bit-search and also the determination of the position of bit edges as discussed further below.

A two-channel fast-sequencing high dynamics GPS navigation receiver is disclosed in U.S. Pat. No. 6,191,730 in which a processing scheme is offered serving to eliminate the need to synchronise any pre-detection or band limiting with the bit edges through the detection first of the phase in a wide bandwidth to create a phase function, and then averaging over a time period which coincides with, or is within, the 20-ms data-bit time during which the signal is coherent.

While the likelihood of correlating over a bit edge of the incoming signal is thereby greatly reduced, the processing steps disclosed in this document nevertheless prove disadvantageously complex and potentially unreliable.

### OBJECT OF INVENTION

The present invention therefore seeks to provide for a method and apparatus for receiving GPS signals and in which coherent integration can be performed in a simple and effective manner avoiding integrating over bit edges.

### SUMMARY OF INVENTION

According to one aspect of the present invention, there is provided a method of the above-mentioned type, characterised by the step of time dividing the received signal into a plurality of signal chunks alternately across at least two channels each channel then carrying a series of signal chunks, the division being controlled in a timed manner with regard to the signal bit period so that the signal chunks of one of the said series do not include bit edges.

In controlling the dividing of the signal in this timed manner, it readily proves possible to provide a channel with a signal exhibiting no bit edges in a simple and reliable manner. It is even advantageously not necessary to know which channel contains all of the bit edges since the signal that is void of bit edges will simply yield a positive detection as a result of the coherent integration.

The feature of claim 2 advantageously offers a particularly simple manner for achieving the advantages of the present invention.

The features of claims 3, 4 and 5 advantageously relate the present invention to use with a GPS system arranged for publicly available mobile communication devices and are directed specifically to the bit period of 20 ms arising in the coarse/acquisition (CA) codes available for civilian GPS applications.

The features of claims 5 and 6 advantageously relate to the adaptability of the present invention.

According to another aspect of the present invention there is provided a direct sequence spread spectrum signal receiver including integration means for obtaining an integration result by avoiding integration over bit edges, characterised by time division means and a plurality of channels arranged such that the time division means serves to separate a received signal into a plurality of signal chunks alternately across the respective plurality of the channels, each channel being arranged to carry a series of original chunks, and including means for controlling the division responsive to the signal bit period so that the signal chunks of one of the series of signals do not include bit edges.

The invention advantageously includes means for executing the method steps as defined above.

### BRIEF DESCRIPTION OF DRAWINGS

The invention is described further hereinafter, by way of example only, with reference to the accompanying drawings in which:

FIG. 1 is a block diagram of a GPS receiver embodying the present invention;

FIG. 2 is a timing diagram illustrating the manner in which the received signal is split in accordance with an embodiment of the present invention; and

FIG. 3 is a timing diagram illustrating the manner in which a received signal is split in accordance with another embodiment of the present invention.

### DETAILED DESCRIPTION

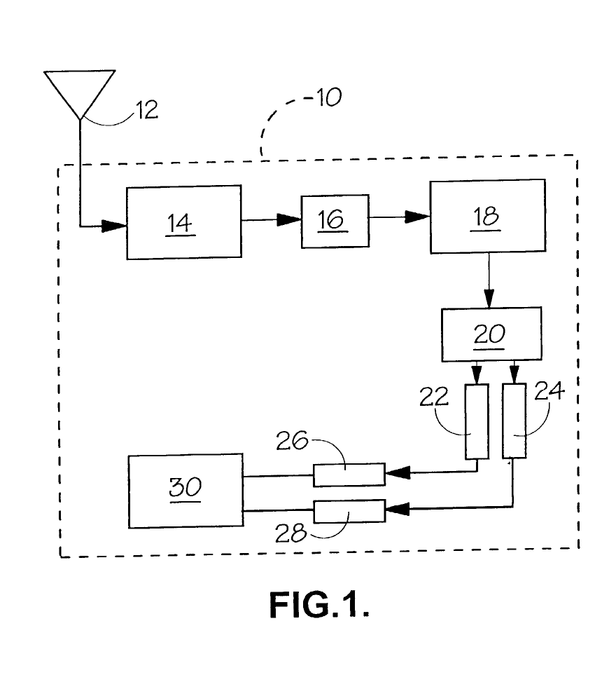

Turning first to FIG. 1, there is illustrated, in block form, a GPS receiver 10 arranged to operate in accordance with the present invention.

The receiver 10 includes a GPS antenna 12 for receiving GPS satellite signals which are in turn delivered to a RF/IF converter 14 so as to provide for an IF signal within the receiver. This IF signal is delivered to an A/D converter 16, the digital output of which is delivered to a memory 18.

The digital IF data stored within memory 18 is then divided by means of a divider-separator 20 into first and second signals which are delivered respectively to first 22 and second 24 channels within the receiver 10. Each of the channels 22, 24 delivers its respective signal to respective correlators 26, 28 which process the signals by means of, amongst other actions, the integration and correlation thereof. The signal thus acquired by means of the integration and correlation is delivered to a digital signal processor 30 for computation of the receiver position etc.

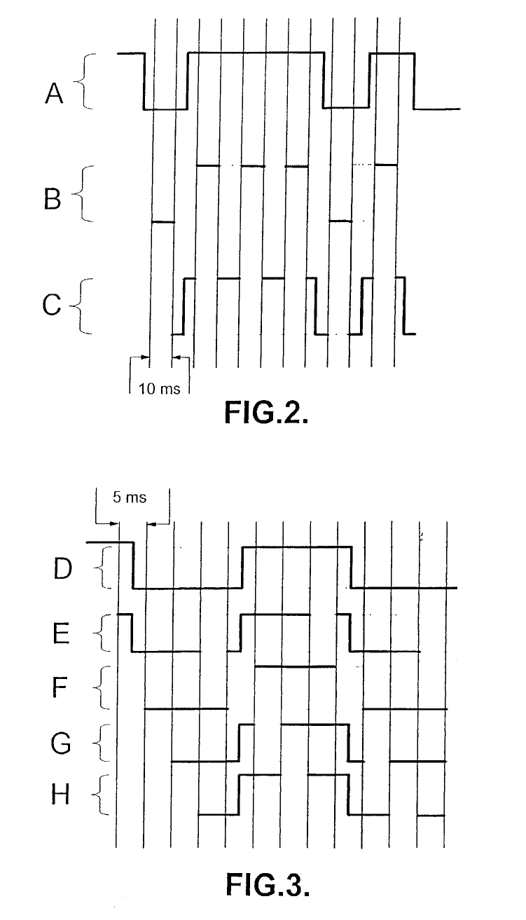

The manner in which the signal is split and shared between the two channels is described further with reference to FIG. 2. In FIG. 2, a trace of the incoming signal A is illustrated and, in this example, comprises a C/A derived signal having a bit period of 20 ms. The vertical dashed lines illustrate the 10 ms time periods into which the signal is split in an alternate manner. Thus, the first, third and fifth etc. chunks divided from the signal trace A is delivered to one channel, whereas the second fourth and sixth etc. chunks are delivered to the other channel. This division and alternate allocation into the two signals continues so as to provide for the two traces B and C. The trace B, for example, being that of the signal on channel 22, whereas the trace C is that of the signal on channel 24.

As will be appreciated, through appropriate choice of the length of each of the chunks, the signal on one of the channels does not contain any bit edges such as that illustrated by trace B.

The original signal is thus split into chunks alternately between the two channels and which series of chunks are then processed independently to try to acquire the GPS satellites. In this example, each channel carries 10 ms chunks of the original signal. One channel will have no bit edges, and the other will contain all of the bit edges and hence can be discarded.

Here, the correlations are performed over 10 ms chunks but the results are divided into “odd” and “even” channels: e.g. the results from 0-10 ms, 20-30 ms, 40-50 ms etc. are in the even channel and results from 10-20 ms, 3040 ms, 50-60 ms are in the odd channel. As noted above and from FIG. 2, one of the channels will contain all of the bit edges and so the other channel will contain no bit edges at all. The idea is that by performing coherent integration employing a bit search independently on both channels, one result will be unaffected by bit edges and hence will yield a positive detection if the signal is present.

The method of the present invention can therefore serve to reduce the complexity of determining bit edges in an attempt to avoid damaging coherent integrations. For example, instead of requiring a search over 20 bit edge locations, a signal trace derived from the original signal and which is void of bit edges is achieved merely through time-division and separation of the original signal and without requiring such a search.

Once the GPS signal is acquired in one of the channels, it is then an advantageously simple matter to return to the other channel and determine where the bit edges actually are and therefore use the whole of the recorded data in the pseudorange measurement. By using the other channel in this manner, it is possible to regain the 3 dB potential signal to noise ratio gain lost by initially considering only half of the original data.

A GPS receiver incorporating the above techniques therefore can achieve fast acquisition yet high sensitivity.

Turning now to FIG. 3, there is illustrated yet another embodiment of the present invention in which an incoming signal, illustrated as trace D, is split into four signals, illustrated by traces E-H.

Again, the incoming signal D is assumed to exhibit a bit period of 20 ms. However, in this example, each of the alternate chunks of the original signal D comprise 15 ms portions which are off-set relative to each other by 5 ms.

As will be appreciated, trace F exhibits no bit edges and so can form the subject for accurate coherent integration. Thus, the channel carrying trace F is the only one not effected by bit edge transitions and so offers a guaranteed 15 ms coherent integration period. As a further alternative, for n channels, an n×15 ms total integration period could be achieved if the 15 ms chunks are offset by 20 ms and summed in each sub-channel carrying the traces E-H. In general, for n channels, (20-20/n) ms can be integrated coherently and which illustrates that the expected advantages diminish as the chunk period approaches 20 ms.

It should be appreciated that the invention is not restricted to the details of the foregoing embodiment. For example, it can be advantageously employed in any positioning system employing direct sequence spread spectrum signals.

1. A method of acquiring direct sequence spread spectrum signals including the steps of obtaining an integration result by avoiding integration over bit edges, characterised by time-dividing the received signal into a plurality of signal chunks alternatively across at least two channels, each channel then carrying a series of signal chunks, the division being controlled in a timed manner responsive to the signal bit period so that the signal chunks of one of the series signals do not include bit edges.

2. A method as claimed in claim 1, wherein the signal is split into two separate series of signal chunks.

3. A method as claimed in claim 1, wherein the bit period of the received signal is 20 ms.

4. A method as claimed in claim 1, wherein the period of each chunk is 10 ms.

5. A method as claimed in claim 1, wherein the signal is split into more than two series.

6. A method as claimed in claim 1, wherein the signal chunks in one series are offset relative to the signal chunks in at least one other series.

7. A method as claimed in any one of claims 1-6, wherein for four n channels (20-20/n) ms can be integrated coherently.

8. A method as claimed in claim 1, wherein the direct sequence spread spectrum signal comprises a GPS signal.

9. A direct sequence spread spectrum signal receiver including integration means for obtaining an integration result by avoiding integration over bit edges, characterised by time-division means and a plurality of channels arranged such that the time-division means serves to divide a received signal into a plurality of signal chunks alternately across the respective plurality of the channels, each channel being arranged to carry a series of signal chunks, and including means for controlling the division in responsive to the signal bit period so that the signal chunks of one of the series of signals is void of bit edges.
